(19) United States
(12) Patent Application Publication
(10) Pub. No.: US 2012/0101841 A1
(43) Pub. Date: Apr. 26, 2012

(54) CLINICAL PROCESS GUIDANCE SYSTEM AND METHODS OF USING SAME

(75) Inventor: Leo Kobayashi, Cranston, RI (US)

(73) Assignee: Leo Kobayashi, Cranston, RI (US)

(21) Appl. No.: 13/278,669

(22) Filed: Oct. 21, 2011

Related U.S. Application Data
(60) Provisional application No. 61/405,325, filed on Oct. 21, 2010.

(51) Int. Cl. G06Q 50/22

(52) U.S. Cl. 705/2

(57) ABSTRACT

The present disclosure provides systems and methods for improving the efficiency and coordination of the treatment of patients in an acute care clinical environment.

### RELATED APPLICATION

This application claims priority from U.S. Provisional Patent Application No. 61/405,325, filed on Oct. 21, 2010, incorporated herein by reference in its entirety.

### FIELD

The present disclosure relates to the field of emergency medicine. More specifically, the disclosure relates to particular systems and methods used to make treatment of patients in an acute care clinical environment more efficient and better coordinated.

### BACKGROUND

Healthcare providers in acute care clinical environments (e.g., emergency departments, in-hospital cardiac arrest settings) often have to perform critical patient care duties under stressful, busy conditions that limit or impair effective communication and teamwork behaviors. Under such circumstances, patient care may be compromised due to the lack of a shared mental model (i.e., a common, distributed understanding of patient presentation, evaluation, management and disposition that serves as a basis on which all care providers function collaboratively) and/or situational awareness (i.e., accurate perspective and encompassing knowledge of clinical and environmental conditions pertaining to patient care) within clinical teams.

There is a need in the art for improved methods to coordinate critical patient care duties in acute clinical care environments.

### SUMMARY

The present disclosure provides an electronic system for coordinating an acute care environment. The system can include software and at least one electronic interactive device comprising a display, wherein the software produces screens on the display showing status of one or more specific clinical care processes in a high visibility format; an automated guidance of clinical activities with pre-programmed audiovisual prompts presented on the display; and a documentation system.

In one embodiment, at least one electronic interactive can be a handheld electronic device, a wall display, or a personal computer. The handheld electronic device is selected from the group consisting of a handheld tablet interface, a smartphone interface and a laptop computer. The wall display can be a projection system.

In another embodiment, at least one electronic interactive device includes an interactive component. The interactive component can be a keyboard, a mouse or a touch screen.

In another embodiment, the system is configured to be used with an acute care environment with multiple bays for multiple patients. In this embodiment, the system can include multiple electronic interactive devices linked by an electronic data connection. The system can also include electronic markers and detectors for these markers at one or more of the bays. Optionally, the markers can be radio frequency identification (RFID) tags and the detector can be an RFID reader.

In certain embodiments, each bay includes at least one electronic interactive device. This electronic interactive device can display information regarding the patient in the bay in which the electronic interactive device is present. The display can show the identity of the patient and/or the responsible physician for the patient. The display can also show the status of a clinical care process being performed on the patient.

In certain embodiments, the clinical care process is sedation or resuscitation. The display can show different interactive screens for different current clinical care processes. The different interactive screens can be selected from one or more sedation or resuscitation screens. The one or more sedation screens can include a planning screen, a preparation screen, a sedation screen or a recovery screen.

In certain embodiments, the planning screen displays a patient history checklist or a patient exam sedation plan. The checklists can be modified by a user to indicate the presence of the listed items or add required data. The patient history checklist can include a patient or family history of anesthesia complications and a list of patient current medications and allergies. The planning screen can also display a readout of vital statistics of the patient. These statistics can include a pulse rate, electrocardiogram, blood pressure, blood oxygen and electroencephalogram.

In certain embodiments, the preparation screen displays a review of equipment for the sedation procedure, a review of preparative steps for the sedation procedure or a review of responsible medical professionals for the sedation procedure. The equipment can include a detectable marker and the electronic interactive device comprises a detector for the detectable marker allowing the presence of the equipment in the vicinity of the patient to be detected. One or more of the medical professionals can possess an identity marker and the electronic interactive device comprises a detector for the identity markers allowing the presence of each medical professional in the vicinity of the patient to be detected.

In certain embodiments, the sedation screen displays a list of medications that are administered to the patient, the mode of administration of each medication, and a list of adverse events associated with each medication. The sedation screen can also display a timer showing the amount of time the patient has been sedated. The sedation screen can also display how long each of medications will be active.

In certain embodiments, the recovery screen displays a checklist for patient examination after sedation. The checklist can include items selected from the group consisting of whether the patient is verbally communicative, whether the patient has sufficient analgesia, whether the mental status of the patient meets pre-sedation baseline, whether the patient has airway reflexes intact, whether the patient has stable cardiopulmonary function, whether the patient has adequate hydration, whether the saturation of peripheral oxygen is sufficient and whether the patient has stable gait. The recovery screen can also display how long the patient should be monitored.

In certain embodiments, the one or more resuscitation screens include a pre-arrival screen, an arrival screen, a resuscitation screen, a maintenance screen, and a disposition screen. The pre-arrival screen can include checklists for EMS referral, personnel and equipment. The EMS checklist can include known potential hazards to clinicians, most recent cardiopulmonary status, medications given, allergies, and clinical, lab or EKG findings. The personnel checklist can include resuscitation team leader assignment, airway management role assignment, chest compressor role assignment, vascular access role assignment, medication administration role assignment, documentation role assignment, and respiratory therapy notification. The equipment checklist can include airway devices to be used, monitoring devices to be used, procedural tools to be used and ultrasound instruments to be used. Each of the pieces of equipment can be labeled with markers for automatic detection in the patient bay area.

In certain embodiments, the system also includes a base electronic interactive device. The base electronic device can provide information for multiple patients in the acute care environment.

The current disclosure also provides a method of providing acute care using the electronic system described above.

The current disclosure also provides a method of producing an efficient acute care environment comprising providing an acute care environment; and installing the system described above.

### BRIEF DESCRIPTION OF THE DRAWINGS

FIG. 1 is a photograph showing a patient bay in an acute care environment with one embodiment of the clinical guidance system described herein.

FIG. 2 is a photograph showing a patient bay in an acute care environment with one embodiment of the clinical guidance system described herein.

FIG. 3 is a photograph showing two patient bays in an acute care environment with one embodiment of the clinical guidance system described herein.

FIG. 4 is a patient status screen from the clinical guidance system described herein.

FIG. 5 is a schematic of RFID assignment of medical professionals to different patients in an acute care environment.

FIG. 6 shows an adult sedation planning screen according to with one embodiment of the clinical guidance system described herein.

FIG. 7 shows an adult sedation preparation screen according to with one embodiment of the clinical guidance system described herein.

FIG. 8 shows an adult sedation screen according to with one embodiment of the clinical guidance system described herein.

FIG. 9 shows an adult sedation recovery screen according to with one embodiment of the clinical guidance system described herein.

FIG. 10 shows an adult sedation documentation screen according to with one embodiment of the clinical guidance system described herein.

FIG. 11 shows an adult resuscitation pre-arrival screen according to with one embodiment of the clinical guidance system described herein.

### DETAILED DESCRIPTION

The disclosure provides a clinical guidance system that promotes care coordination and informational dissemination within and across caregiver teams during specialized healthcare activities (procedural sedation, medical and trauma resuscitations.

In one embodiment, the system includes stand-alone packaging of relevant clinical information and parameters into a simple, focused, high-visibility format to establish and maintain a shared mental model of care activities within the clinical team (e.g., role assignment, task checkbacks, patient management plan). In another embodiment, the system includes prominent display of up-to-date global status and of specific clinical care processes to assist in monitoring the progression of high-risk healthcare activities (e.g., resuscitation of critical medical or trauma patients, procedural sedation). In another embodiment, the system also includes automated guidance of clinical care activities with pre-programmed audiovisual prompts/reminders for critical actions. In another embodiment, the system also includes post-sedation/-resuscitation summative documentation of system functions to serve as a complementary element of medical records.

The clinical guidance system described herein can employ handheld and/or untethered computer devices connected to wide-viewing angle/large-format displays and running specialized software interfaces to synchronize and coordinate individual clinical team members into a team with respect to their perceptions, tasks, roles and involvement during complex medical activities.

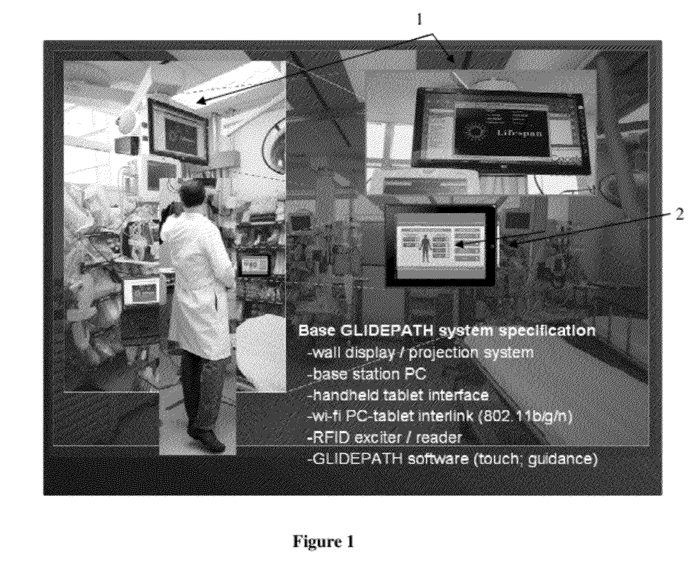

One embodiment of the clinical guidance system described herein has been termed the Graphic Link for Informational Distribution/Exchange for Provider Awareness and Teamwork in Healthcare (GLIDEPATH) system. GLIDEPATH is designed for specialized healthcare activities (medical and trauma resuscitations, procedural sedation) in acute care environments outside of operating rooms. Its scope and emphasis on simplicity in conjunction with the integration of RFID and wireless technologies, clinical process guidance, remote control function, stand-alone deployment capability and portability, simple visual interface, lower cost of implementation and setting/discipline-specific dedicated software that allows for wireless communication of clinical data to audiovisual broadcasting displays and summative documentation, differentiate the GLIDEPATH system. This system is shown in greater detail in FIGS. 1-11.

FIG. 1 shows a photograph of the GLIDEPATH system implemented in a patient bay in an acute care environment. A wall display (1) run by a base station personal computer (PC) as well as a handheld portable tablet (2) show patient information on a variety of screens, generated by the GLIDEPATH software, guiding clinicians through the current clinical process. The electronic devices are linked via a Wi-Fi™ (IEEE 802.11) Internet connection. A RFID exciter/reader is also present to detect the presence and identity of a patient present in the bay. Moreover, the RFID exciter/reader can be programmed to detect the presence of necessary equipment or personnel. Personnel can also be detected by presenting their badges or other security device to a dedicated reader in the bay.

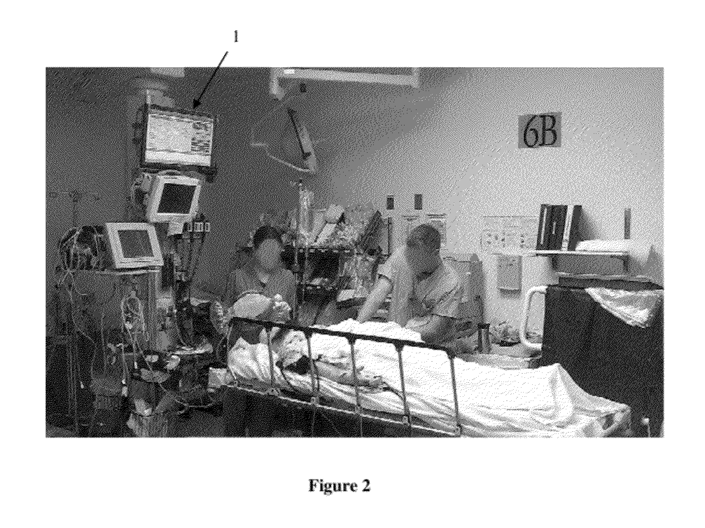

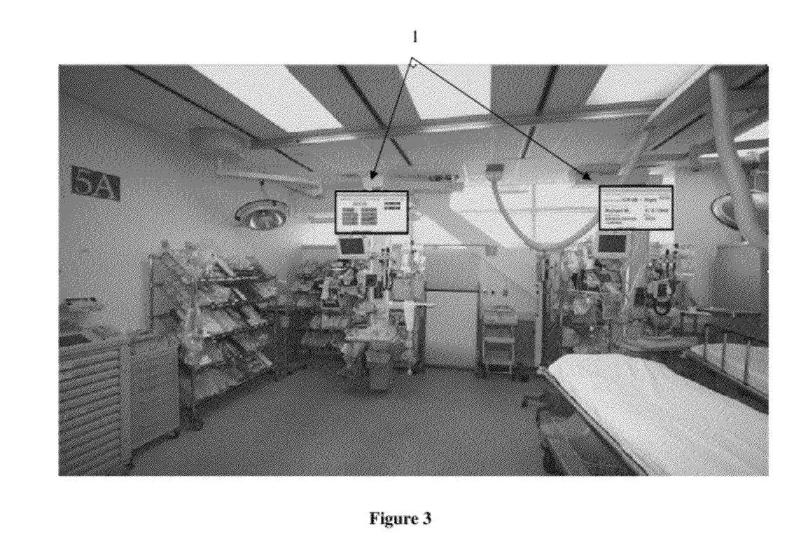

FIG. 2 shows another patient bay with the GLIDEPATH system installed. The wall display (1) is positioned above the patient. FIG. 3 shows the GLIDEPATH system arranged in a multiple patient bay. Here, RFID exciter/readers are positioned in the bay so that a patient placed in one bay is differentially identified as compared to a patient in the other bay. Thus, information and status for the two patients is kept separate.

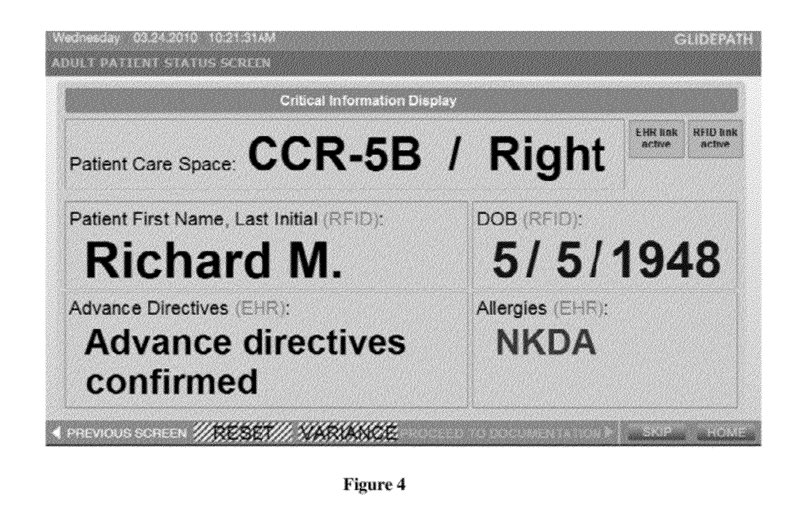

GLIDEPATH operates by presenting a sequence of screens on a display with which medical personnel can interact in order to input information, check that certain tasks have been performed and to check on already existing information regarding a patient. FIG. 4 shows a patient information screen used on GLIDEPATH. This screen shows the patient's name, care space, date of birth, allergies and advance directives. The screen could also show an identification number associated with the patient, pathological status, medical information or medical professionals assigned to the patient.

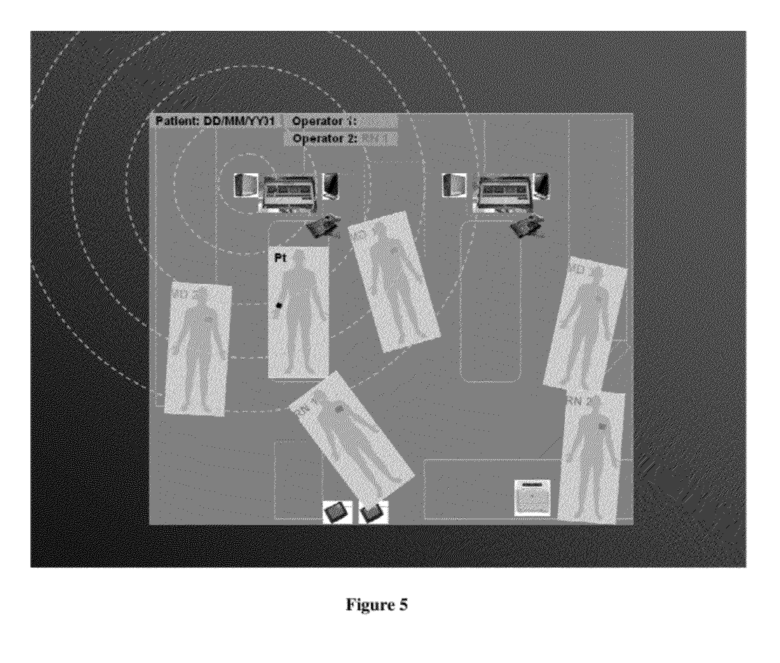

As shown in FIG. 5, this system can be used to ensure that patient information is assigned to the correct patient, even in a disordered acute care environment. RFID tags placed on the patients can be detected by the system and the patient's information can be displayed on the nearest electronic device. Further, patients placed in a particular patient bay will be identified in the system as being present in the bay. Thus, the bay's electronic devices will display the correct information for the correct patient. Also, other electronic devices remote from the bay can show that the bay is occupied and by whom. RFID tags can be placed on badges or bracelets or any other object provided to the patients.

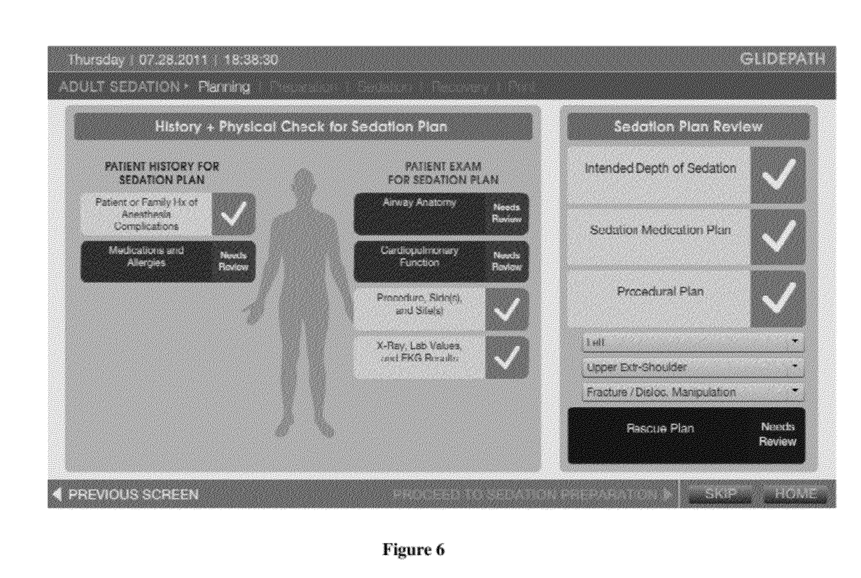

FIG. 6 shows an adult sedation planning screen used with GLIDEPATH. This screen ensure that the appropriate patient and family history and allergy information is obtained and reviewed as shown in the touch screen on the right. Further, the system reminds medical personnel that airway anatomy, cardiopulmonary function, procedure sites and X-ray, lab and EKG results must be reviewed prior to sedation. Further, the plan for sedation including intended depth of sedation, medication plan and procedural plan are reviewed as wells as a rescue plan. As each of the reminders is fulfilled, medical personnel can use the interactive electronic devices associated with the GLIDEPATH system to fill in the check lists or to add the necessary information.

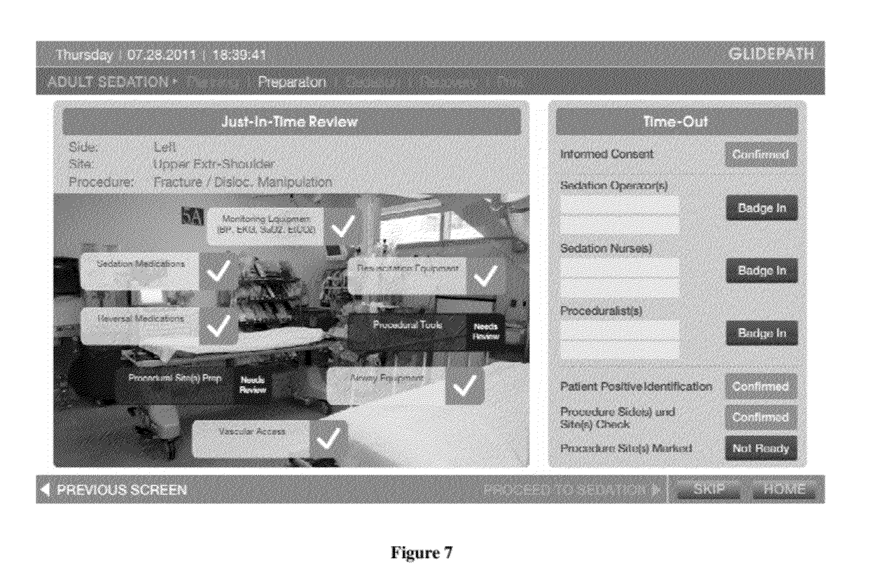

FIG. 7 shows an adult sedation preparation screen used with GLIDEPATH. On the left, the presence of necessary equipment is arranged as a checklist for medical personnel. Equipment can be automatically detected by the GLIDEPATH system using any sort of detector/reader technology, such as RFID, to detect the presence of various pieces of equipment. This information can also be manually checked and updated by medical personnel. A checklist for tools and procedural site preparation are also present to remind medical personnel. On the right, an informed consent reminder is shown. Also, shown are badge in's for the necessary medical personnel. These badge in's can be performed automatically by the presence of any detector/reader technology. Personnel may possess badges with RFID tags that allow for their presence to be detected in a patient bay. Further, medical personnel may possess identification that allows for them to electronically sign into the bay, for example, using bar codes on identification materials. Also, biometric identification may be performed, for example, by thumbprint. Identification may also be performed by each medical personnel inserting a password or by signing in. Patient positive identification, procedure site and procedure site marking reminders can also be included.

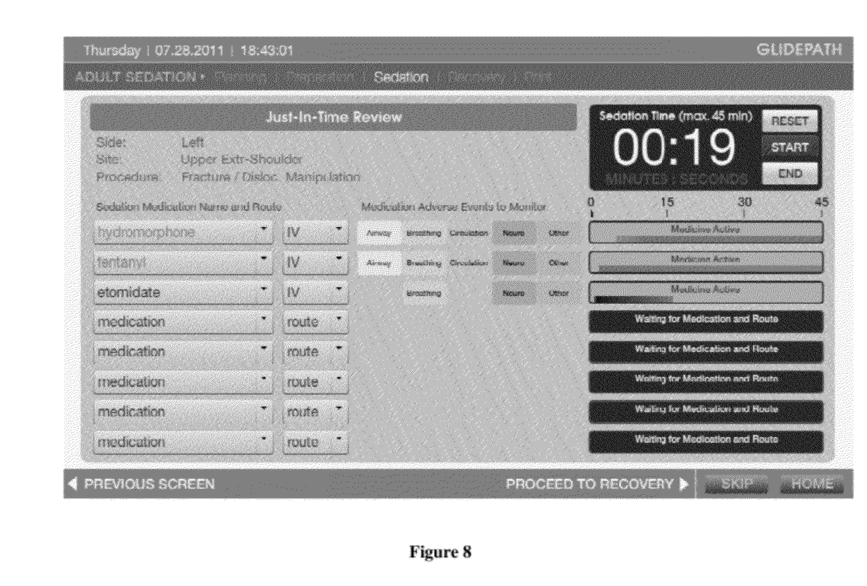

FIG. 8 shows an adult sedation screen used with GLIDEPATH. The screen shows which drugs are being administered and how they are being administered. This list generates a list of possible adverse events to monitor. The required sedation time is shown in the upper right hand corner. Below this are the times that the listed drugs will be active. Medical personnel can use pull down menus or typing input devices to insert the appropriate drugs and administration routes on this screen. The screen also reiterates the position of the procedure and what type of procedure it is.

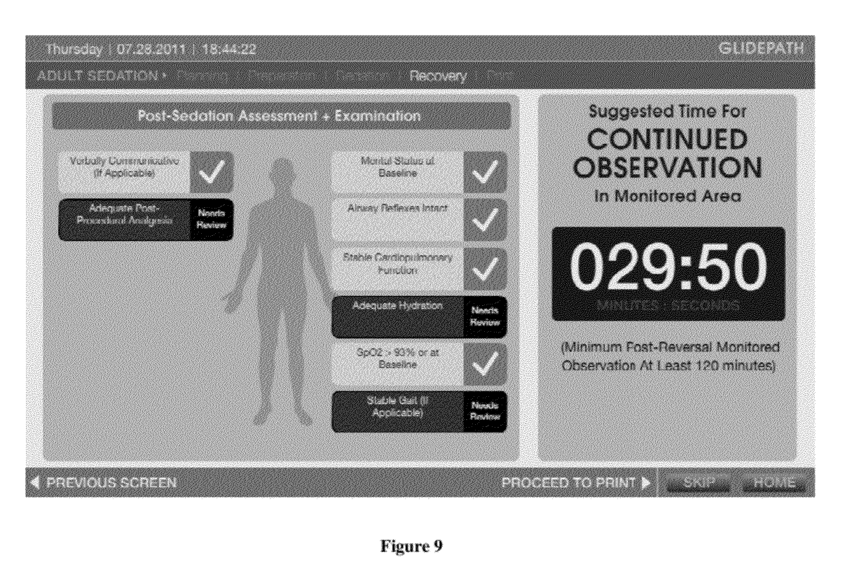

FIG. 9 shows an adult sedation recovery screen used with GLIDEPATH. This screen presents a check list of clinical outputs from a patient recovering from sedation. These include whether the patient is verbally communicative, whether the patient has adequate post-procedural analgesia, the patient's mental status at baseline, whether the patient's airway reflexes are intact, whether the patient has stable pulmonary function, whether the patient has adequate hydration, whether the patient has sufficient peripheral oxygen and whether the patient has stable gait. This screen also presents a countdown showing the suggested time for patient observation after sedation.

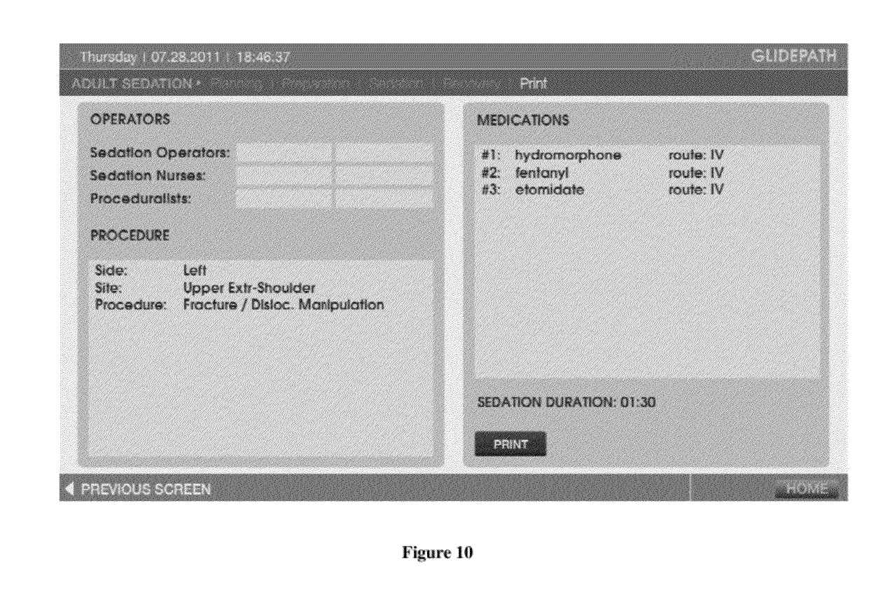

FIG. 10 shows an adult sedation documentation screen used with GLIDEPATH. The documentation screen can be populated with the medical personnel who were involved with sedation, what procedure was performed and at what site, what medications were administered and how long sedation occurred. Any and all information from the procedure can be generated in the documentation screen either for printing a hard copy or electronic storage.

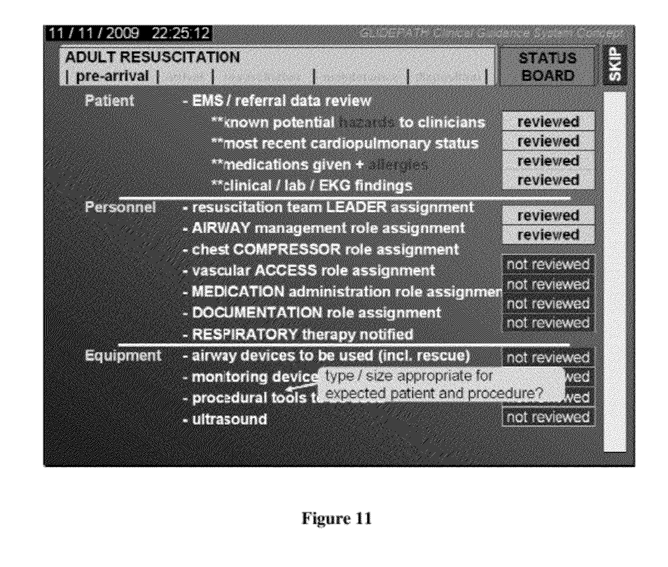

Screens can be devised that would be appropriate for any medical procedure. For example, FIG. 11 shows a pre-arrival screen for a patient to be resuscitated. Interactive checklists are provided for EMS/referral data, personnel data, and equipment data. EMS/referral data includes known potential hazards to clinicians, most recent pulmonary status of the patient, medications give, patient allergies, as well as clinical, lab or EKG findings. Personnel data includes resuscitation team leader assignment, airway management role assignment, chest compressor role assignment, vascular access role assignment, medication administration role assignment, documentation role assignment and respiratory therapy notification. These assignments may be generated in any of the ways described above for the GLIDEPATH sedation screens. Equipment data includes airway devices to be used, monitoring devices to be used, procedural tools to be used and ultrasound equipment to be used. Equipment can be identified automatically or manually according to any of the ways described above for GLIDEPATH sedation screens.

Other screens could also be devised. Any of the items in any of the screens described above are optional and interchangeable. The various checklists can be modified and presented in any way that is useful for medical professionals.

These screens are presented on displays of electronic devices. These displays can be wall displays or displays on portable and/or handheld electronic devices. The information on these screens can also be summarized on other displays in the acute care environment remote from patient bays. The information is relayed between electronic devices via electronic data connections. Portable electronic devices can be used to display screens appropriate for a patient that they are in proximity with. For example an electronic device that is within 5, 6, 7, 8, 9, 10, 11, 12, 13, 14, 15, 16, 17, 18, 19 or 20 feet of a given patient can produce screens relevant to the condition of that patient. Alternatively, electronic devices can be assigned to a given patient regardless of their distance from the patient. For example, a medical professional would be able to monitor the status of a patient while being at a distance from the patient with a portable electronic device.

A base PC can be used to monitor some or all of the patients in an acute care environment. The position of the patients within the environment can be displayed as can the medical personnel assigned to the patient. The information is relayed to the base PC via electronic data connections. Moreover, any of the data generated on the various screens associated with the system described herein could be monitored or interacted with at a base PC.

As used herein, “an electronic system” refers to one or more electronic devices operating on software working for a unified purpose. When two or more electronic devices are used they can be connected so as to share data by an “electronic data connection”. This connection can occur via any kind of wired or wireless Internet connection including a Wi-Fi™ (IEEE 802.11) connection.

As used herein, “electronic interactive device” refers to a computer. For example, a personal computer (PC), tablet PC, laptop or smartphone.

As used herein, “an acute care environment” is any medical environment in which acute care is provided for patients. These environments can include emergency departments in hospitals, medical departments in military contexts, mobile medical environments used for disaster relief or emergency medical environments including ambulances.

As used herein, “displays” refer to electronic displays including computer monitors, tablet displays, smartphone displays and television screens.

As used herein, “screen” refers to a particular representation on a display. The screen is an interactive image presenting data and also accepting input from medical personnel. The input can be performed via any interactive device. Data can be presented as checklists or as more traditional data displays such as EKGs, pulse rate monitors and the like.

As used herein, “medical personnel” refers to doctors, nurses, emergency medical technicians, nurse's assistants and other trained personnel who regularly work in acute medical environments.

As used herein, “high visibility format” is a format from which data can be perceived from a distance from a display. In certain embodiments, this distance is at least, 5, 10, 20, 30, 40 or 50 feet.

As used herein, “clinical care processes” refers to processes medical personnel perform on or with patients receiving emergency care. These processes include procedural sedation, and resuscitation for medical critical and trauma patients.

As used herein, “a bay” is a position in a critical care environment in which a patient can be placed in order for clinical care processes to be performed. A multiple bay clinical environment gas positions in the environment for multiple patients.

As used herein, “an electronic marker” is any marker that can be used to locate the position of an object in space. One example of such a marker is a radio frequency identification tag. An “electronic detector” is a detector that can locate an electronic marker in space. One example of such a detector is an RFID exciter/reader.

The system and methods of the present disclosure are not to be limited in scope by the specific embodiments describe herein. Indeed, various modifications of the invention in addition to those described herein will become apparent to those skilled in the art from the foregoing description. Such modifications are intended to fall within the scope of the appended claims.

What is claimed is:

1. An electronic system for coordinating an acute care environment comprising software and at least one electronic interactive device comprising a display, wherein the software produces screens on the display showing
a) status of one or more specific clinical care processes in a high visibility format;
b) an automated guidance of clinical activities with pre-programmed audiovisual prompts presented on the display; and
c) a documentation system.

2. The electronic system of claim 1, wherein at least one electronic interactive device is selected from the group consisting of a handheld electronic device, a wall display, or a personal computer.

3. The electronic system of claim 2, wherein the handheld electronic device is selected from the group consisting of a handheld tablet interface, a smartphone interface and a laptop computer.

4. The electronic system of claim 2, wherein the wall display is a projection system.

5. The electronic system of claim 1, wherein at least one electronic interactive device comprises an interactive component.

6. The electronic system of claim 1, wherein the interactive component is selected from the group consisting of a keyboard, a mouse and a touch screen.

7. The electronic system of claim 1, wherein the system is configured to be used with an acute care environment with multiple bays for multiple patients.

8. The electronic system of claim 7, wherein the system comprises multiple electronic interactive devices linked by an electronic data connection.

9. The electronic system of claim 7, wherein the system further comprises electronic markers and detectors for these markers at one or more of the bays.

10. The electronic system of claim 9, wherein the markers comprise radio frequency identification (RFID) tags and the detector comprises an RFID reader.

11. The electronic system of claim 7, wherein each bay comprises at least one electronic interactive device.

12. The electronic system of claim 11, wherein the at least one electronic interactive device displays information regarding the patient in the bay in which the electronic interactive device is present.

13. The electronic system of claim 12, wherein the display shows the identity of the patient.

14. The electronic system of claim 12, wherein the display shows the responsible physician for the patient.

15. The electronic system of claim 12, wherein the display shows the status of a clinical care process being performed on the patient.

16. The electronic system of claim 7, wherein the system further comprises a base electronic interactive device.

17. The electronic device of claim 16, wherein the base electronic device provides information for multiple patients in the acute care environment.

18. A method of providing acute care using the electronic system of claim 1.

19. A method of producing an efficient acute care environment comprising
a) providing an acute care environment; and
b) installing the system of claim 1.
